(19) United States
(12) Patent Application Publication
(10) Pub. No.: US 2024/0396199 A1
(43) Pub. Date: Nov. 28, 2024

(54) IN-LINE WAVEGUIDE MODE CONVERTER

(71) Applicant: NUIONIC TECHNOLOGIES (CANADA) INC., Fredericton (CA)

(72) Inventors: James M. TRANQUILLA, Fredericton (CA); Kenneth CLARK, Fredericton (CA)

(21) Appl. No.: 18/694,841

(22) PCT Filed: Sep. 23, 2022
(86) PCT No.: PCT/CA2022/051417

§ 371 Date: Mar. 22, 2024

Related U.S. Application Data
(60) Provisional application No. 63/247,508, filed on Sep. 23, 2021.

(51) Int. Cl. H01P 5/103; H01P 1/161; H01P 3/20

(52) U.S. Cl. CPC H01P 5/103; H01P 1/161; H01P 3/20

(57) ABSTRACT

A microwave transmission structure is disclosed that includes a mode converter coupling a rectangular waveguide section in which microwave energy propagates in a first mode to a transmission line section in which microwave energy propagates in a second mode. The waveguide section, the mode converter and the transmission line section are cooperatively configured and arranged along a common propagation axis such that microwave energy can propagate in a linear direction through the microwave transmission structure while undergoing a mode conversion at the mode converter.

### RELATED APPLICATIONS

This application claims the benefit of and priority to: U.S. Provisional Patent Application No. 63/247,508 filed Sep. 23, 2021 entitled “IN-LINE WAVEGUIDE MODE CONVERTER”, the contents of which are incorporated herein by reference.

### FIELD

This disclosure is directed to methods and systems for converting microwave energy from a first mode to a second mode.

### BACKGROUND

Cylindrical microwave reactors typically include a closed vessel (e.g., a reactor) that is under high pressure and temperature and receives microwave energy from a microwave generator coupled to the closed vessel by a microwave transmission structure. In known solutions, the microwave transmission structure can include a rectangular cross-section waveguide that is coupled to either a circular cross-section waveguide or a coaxial transmission line that is used to deliver the microwave energy into the reactor. The transition from the rectangular waveguide into either a cylindrical waveguide or coaxial transmission line commonly involves a right-angle interface from the rectangular waveguide.

The use of a right-angle interface can be problematic in scenarios where space is constrained. For example, in a situation where it is desirable to locate multiple reactors in close proximity to each other, reactor spacing can be adversely impacted by the space required for multiple respective microwave transmission structures that each incorporate a right-angle interface. For example, several reactors closely spaced together can introduce problems that prevent or hinder the aligning and separating of the microwave transmission structures without mechanical interference.

Accordingly, there is a need for a space-efficient microwave transmission structure that can transition microwave energy between a rectangular waveguide and a further microwave transmission component.

### SUMMARY

According to a first example aspect of the disclosure a microwave transmission structure is disclosed that includes a mode converter coupling a rectangular waveguide section in which microwave energy propagates in a first mode to a transmission line section in which microwave energy propagates in a second mode. The waveguide section, the mode converter and the transmission line section are cooperatively configured and arranged along a common propagation axis such that microwave energy can propagate in a linear direction through the microwave transmission structure while undergoing a mode conversion at the mode converter.

In some examples of the first aspect, first mode is a transverse electric (TE) mode and the second mode is a transverse electromagnetic mode (TEM) mode.

In one or more of the preceding examples, the mode converter includes an electrically conductive element that forms a terminal wall of the waveguide section, the electrically conductive element including at least one aperture lens extending there through, the aperture lens enabling a TE mode component of the microwave energy to propagate between the waveguide section and an interior of the mode converter.

In one or more of the preceding examples, the mode converter provides an internal pressure barrier between the transmission line section and the waveguide transmission section.

In one or more of the preceding examples, the aperture lens is formed from a solid dielectric material, the electrically conductive element and the aperture lens forming the internal pressure barrier.

In one or more of the preceding examples, the mode converter includes a first central conductor electrically coupled to the electrically conductive element, the first central conductor extending along a central axis of the microwave transmission structure from a first side of the electrically conductive element into the waveguide section.

In one or more of the preceding examples, a second end of the first central conductor is coupled by a conductive structure to a wall of the waveguide section at a location that is spaced apart from the first side of the electrically conductive element.

In one or more of the preceding examples, a second central conductor electrically coupled to the electrically conductive element, the second central conductor extending in an opposite direction than the first central conductor along the central axis from a second side of the electrically conductive element, the second central conductor including a first portion extending through and forming a central conductor of the mode converter and a second portion forming a central conductor of the transmission line section. The transmission line section comprises an electrically conductive outer wall that is radially spaced from the second portion of the second central conductor. The mode converter comprises an electrically conductive cylindrical wall section extending from the electrically conductive element to a conductive tapering wall section that extends from the conductive cylindrical wall section to the electrically conductive outer wall of the transmission line section, the cylindrical wall section and tapering wall section being radially spaced from the first portion of the second central conductor.

In one or more of the preceding examples, the first central conductor is arranged to provide a TEM mode component within the waveguide structure to enable the aperture lens to propagate the TE mode component between the waveguide section and the interior of the mode converter.

In one or more of the preceding examples, the waveguide section, the mode converter and the transmission line section collectively define a common conductive outer surface of the microwave transmission structure.

In one or more of the preceding examples, the waveguide section, the mode converter and the transmission line section collectively define a common conductive outer surface of the microwave transmission structure.

In one or more of the preceding examples, the waveguide section is formed by a rectangular waveguide.

In one or more of the preceding examples, the microwave transmission structure is arranged to provide microwave energy to an interior of a reactor operating under positive pressure, the microwave transmission structure comprising a sealing structure on an outer surface thereof at a location of entry of the microwave transmission structure to the reactor, the sealing structure forming part of a pressure boundary of the reactor.

According to a further example aspect, a microwave reactor system is disclosed that includes a plurality of reactors, each of the reactors being coupled to a respective microwave transmission structure according to any one of the preceding examples.

According to a further example aspect, a method of transmitting microwave energy is disclosed using a microwave transmission structure according to any one of one of the preceding examples, including: receiving microwave energy at the waveguide section from a microwave generator; propagating the microwave energy along the waveguide section in the first mode; converting, at the mode converter, the microwave energy from the first mode to the second mode while propagating the microwave energy through the mode converter to the transmission line section; and propagating the microwave energy along the transmission line section in the second mode.

### BRIEF DESCRIPTION OF DRAWINGS

Reference will now be made, by way of example, to the accompanying drawings which show example implementations of the present application, and in which:

FIG. 1 is a schematic diagram of a system that includes a microwave transmission structure coupling a microwave generator to a reactor according to an example embodiment of the present disclosure;

FIG. 2 is a perspective cutaway view illustrating a microwave transmission structure that can be applied to the system of FIG. 1;

FIG. 3 is a side cutaway view, showing the interior of the microwave transmission structure of FIG. 2;

FIG. 4 is a top cutaway view, showing the interior of the microwave transmission structure of FIG. 2;

FIG. 5 is an end view of the microwave transmission structure of FIG. 2; and

FIG. 6 is a schematic diagram of a system that includes a plurality of the microwave transmission structures of FIG. 1 coupling microwave generators to respective reactors according to an example embodiment of the present disclosure.

### DETAILED DESCRIPTION

According to example embodiments a microwave transmission structure is disclosed that includes an in-line microwave transition interface that couples a rectangular waveguide section to a cylindrical transmission structure without requiring a right-angle interface. In at least some applications, for example in the case of microwave reactor applications, the elimination of a right-angle interface can enable a group of reactors and the respective microwave transmission structures that provide microwave energy to the reactors to be efficiently arranged within an allotted space.

The disclosed microwave transmission structure can also enable the use of simple pressure barrier structures at position(s) where the microwave transmission structure enters a pressure boundary of the reactor.

In example embodiments, the in-line microwave transition interface includes a mode-converting element that includes one or more dielectric-filled apertures placed in a conducting metallic plate which is in direct communication with the ends of both a rectangular waveguide section and a cylindrical waveguide section.

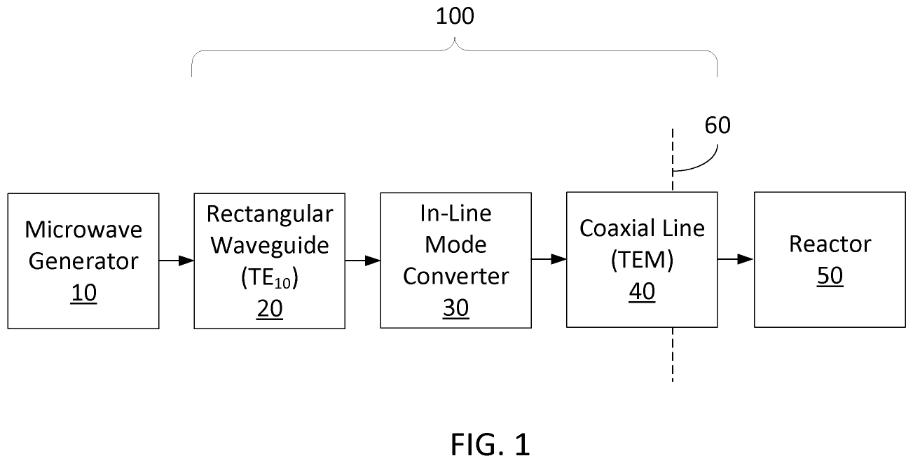

FIG. 1 is a schematic diagram of a microwave reactor system that includes a microwave transmission structure 100 coupling a microwave generator 10 to a closed vessel (e.g., a reactor 50) according to an example embodiment of the present disclosure. The microwave transmission structure 100 includes an in-line mode converter 30 that functions as microwave transition interface between a rectangular wave-guide section 20 and a coaxial transmission line section 40. Microwave energy is produced in the microwave generator 10 and conveyed in transverse electric (TE) mode (e.g. TE₁₀ mode) in rectangular waveguide section 20 to the mode converter 30. The mode converter 30 transforms microwave energy from TE mode into the transverse electromagnetic (TEM) mode required for the coaxial transmission line section 40. The coaxial transmission line section 40 conveys the microwave energy into the reactor 50.

Commonly, the reactor 50 operates at a positive pressure with respect to its surrounding environment, hence there is a need to prevent the escape of reactor products, for example gaseous products. This can be done by maintaining a pressure boundary 60 around the reactor, including at an interface between the reactor 50 and the transmission structure 100. Accordingly, in example embodiments, a pressure barrier structure is located at the point of entry of the transmission structure 100 (e.g., coaxial transmission line 40) into the reactor 50 to form a seal.

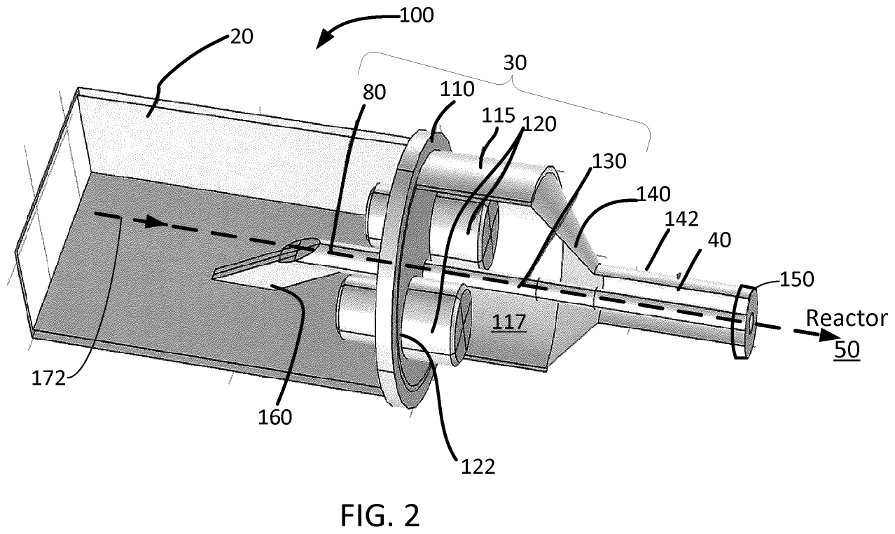

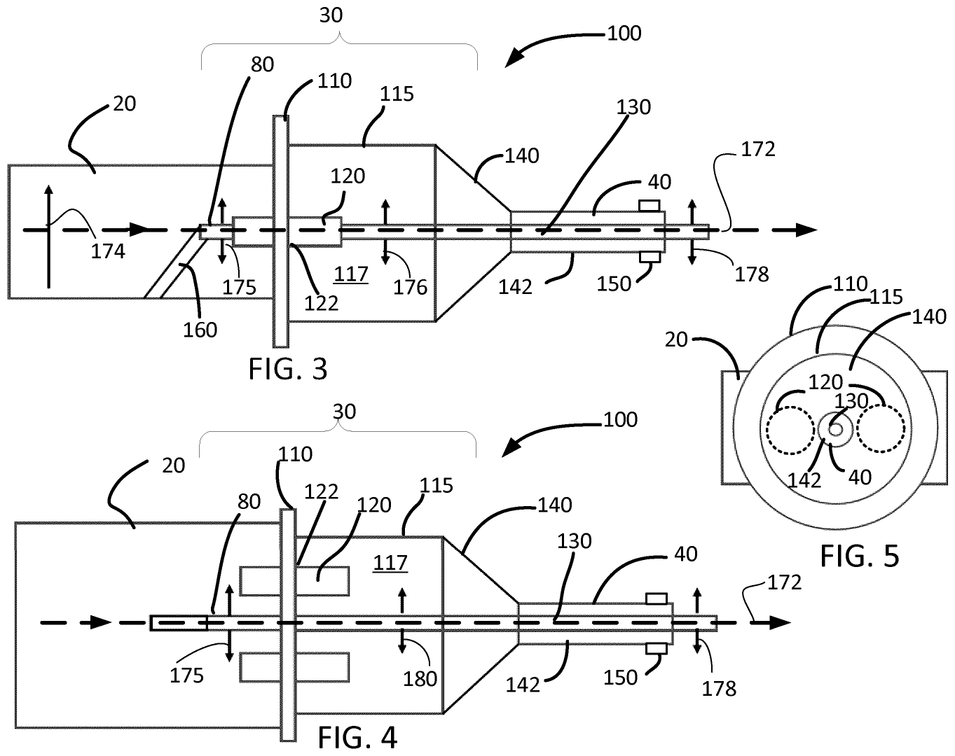

An example embodiment of transmission structure 100 that can be applied to the microwave reactor system of FIG. 1 will now be described with reference to FIGS. 2 to 5. FIG. 2 is a perspective cutaway view illustrating microwave transmission structure 100, FIG. 3 is a side cutaway view, showing the interior of the microwave transmission structure 100, FIG. 4 is a top cutaway view, showing the interior of the microwave transmission structure 100, and FIG. 5 is an end view of the microwave transmission structure 100.

With reference to FIGS. 2, 3 and 4, a central axis 172 of the transmission structure 100 is illustrated by a dashed line that also corresponds to a direction of the propagation of microwaves along the transmission structure 100 into reactor 50. The transmission structure 100 includes electrically conductive rectangular waveguide section 20, mode converter 30, and coaxial transmission line section 40, all of which are arranged in-line along common central axis 172. As used herein in in-line can refer to a linear path in a direction of microwave propagation.

Within the rectangular waveguide section 20, the electric field of the propagating microwaves is perpendicular (represented by line 174 in FIG. 3) to the direction of microwave propagation, in the usual TE mode configuration (e.g., TE₁₀ mode). Within the coaxial transmission line section 40, both the electric and magnetic fields of the propagating microwaves are perpendicular (electromagnetic (EM) field represented by lines 178 in FIG. 3 and FIG. 4) to the direction of microwave propagation, in the usual TEM mode configuration.

Mode converter 30 functions as a TE mode to TEM mode converting interface between the rectangular waveguide section 20 and the coaxial transmission line section 40. In this regard, mode converter 30 includes an electrically-conductive metallic element that forms a terminal wall of the rectangular waveguide section 20. In the illustrated example, the metallic element is a conductive plate 110 that terminates the rectangular waveguide section 20. A first central conductor 80 that is affixed to a first side of plate 110 extends axially towards a feed end of the rectangular waveguide section 20. Mode converter 30 also includes an electrically-conductive cylindrical wall section 115 that extends from a second side of the circular plate 110 that faces in the opposite direction of the first side of the circular plate 110. Mode converter 30 includes an electrically-conductive tapered wall section 140 (e.g., a conical wall) that forms a smooth transition between an end of the cylindrical wall section 115 and a start of an electrically-conductive outer cylindrical wall 142 of the coaxial transmission line section 40. A second central conductor 130 is affixed to and extends axially from the second side of the plate 110 within the axially aligned cylindrical wall section 115, tapered wall section 140, and outer cylindrical wall 142. The portion of the second central conductor 130 extending within cylindrical wall section 115 and tapered wall section 140 forms a central conductor of the mode converter 30 and the portion extending through the outer cylindrical wall 142 forms the central conductor of the coaxial transmission line section 40.

The outer wall that defines the rectangular waveguide section 20, an outer periphery of plate 110, the cylindrical wall section 115, the tapered wall section 140, and the outer cylindrical wall 142 collectively form a continuous common electrically-conductive exterior surface for the transmission structure 100. In some examples, electrically conductive components of the transmission structure 100 are formed from metal. The first central conductor 80 has one end thereof electrically connected to the center of the first side of plate 110, and its extending end is electrically coupled to a wall of the rectangular waveguide section 20 by a conductive structure 160 (e.g., a vane). The conductive structure 60 is attached to a location of the waveguide wall that is axially spaced from the plate 110. An intermediate section of the first central conductor 80 located between the conductive structure 60 and the first side of plate 110 is centrally located in the rectangular waveguide section 20 without touching the walls thereof. In example embodiments, first central conductor 80 can have a length in the range 0.40-0.50 free-space wavelength of the intended microwave operating frequency. The second central conductor 130 is aligned along central axis 172 with the first central conductor 80 and has one end thereof electrically connected to the center of the second side of plate 110, with the extending portion of the second central conductor 130 being spaced apart from each of the cylindrical wall section 115, tapered wall section 140, and outer cylindrical wall 142. The intervening radial space between the second central conductor 130 and the inner continuous conductive surface that is collectively formed by the cylindrical wall section 115, tapered wall section 140, and outer cylindrical wall 142 is filled with a dielectric, which may, for example, be a gaseous dielectric such as air. Rectangular waveguide section 20 is also filled with a dielectric, which may, for example, also be a gaseous dielectric such as air.

In the illustrated example, the plate 110 includes at least one axially off-set dielectric aperture lens 120 that projects into the respective interiors of both the rectangular waveguide section 20 and the model converter 30 through a respective opening 122 that is provided through the plate 110. The aperture lens 120 provides a path for the electric field component of TE mode microwaves to propagate from within the rectangular waveguide section 20 to a cylindrical section 117 of the mode converter 30 defined by cylindrical wall section 115. The mode converter 30 can include more than one aperture lens 120 (for example, two aperture lenses 120 are shown in FIGS. 2 to 5). If there is only one aperture lens 120, it can be located at a radial distance offset from the central axis 172. If there are more than one such aperture lenses 120, they can be arranged in symmetrically opposed pairs about the central axis 172.

In the illustrated example, the dielectric aperture lenses 120 are inserted through and secured within openings 122 and are formed from a solid material such as a ceramic material which is tolerant to high temperatures and pressures, has very low thermal conductivity and also exhibits low electrical losses at the microwave frequencies being used. In some example, the ceramic material can be formed from a composition of Alumina. The one or more dielectric aperture lenses 120 together with plate 110 provide a pressure barrier within the interior of the transmission structure 100, forming a seal between the rectangular waveguide section 20 and the remainder of the transmission structure 100.

During operation, microwaves produced in the microwave generator 10 propagate in TE mode (e.g. TE₁₀ mode) along rectangular waveguide section 20 to the mode converter 30. The interaction of the microwave energy with the first central conductor 80 of the mode converter 30 creates a TEM mode microwave component 175 within the rectangular waveguide section 20. This can enable the aperture lenses 120 to convey a TE mode microwave component into cylindrical waveguide section 117.

The TE mode microwave wave component which is conveyed through the lens apertures 120 couples effectively to a TEM mode microwave within the cylindrical wall section 115, tapering wall section 140 and the coaxial transmission line section 40. In particular, the alignment of the electric field in the lens apertures 120 is coincident with the electric field alignment of the TEM mode in the cylindrical wall section 115, hence these co-aligned field components allow the (bi-directional) transmission of electromagnetic energy between the rectangular waveguide section 20 and cylindrical coaxial transmission line section 40. In FIGS. 3 and 4, the TEM mode microwaves are illustrated by lines 180 emitting from second central conductor 130 within the cylindrical wall section 115 and tapering wall section 140, and lines 178 in the coaxial transmission line section 40.

Microwave energy is thereby effectively conveyed from the rectangular waveguide 20 to the coaxial line 40 without the necessity of a continuous discrete central conductor. Rather, in the illustrated embodiment a central conductor is implemented with first and second central conductors 80, 130 that are each respectively electrically terminated on opposite respective sides of the conducting plate 110, which can provide an effective part of the pressure boundary 60 around the reactor 60. To complete the pressure boundary 60 barrier, one or more O-rings 150 are mounted on either an outer surface of the coaxial transmission line 40 or the outer surface of mode converter 30 surface at the point(s) where the microwave transmission structure 100 enters a pressure containment vessel that is defined by reactor 50. In at least some applications, internal O-rings can be omitted within the mode converter 30 and coaxial transmission line section 40.

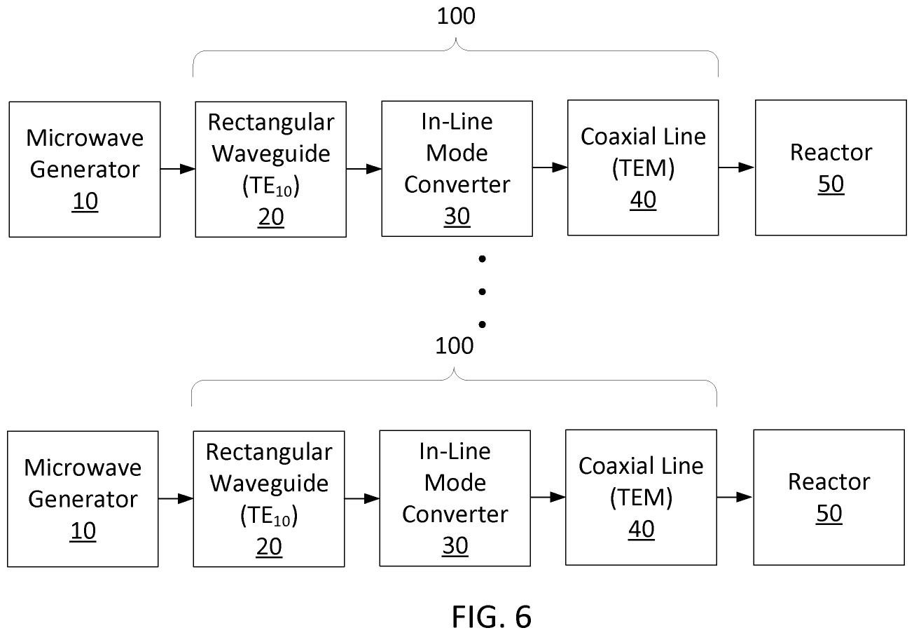

Further, the in-line mode converter 30 eliminates the need for right angle interface and enables a space efficient in-line microwave transmission structure 100 that can support close spacing of reactors 50 within a space-restricted region. FIG. 6 illustrates an example of a plurality of microwave transmission structures 100 arranged in physically parallel paths to apply microwave energy to respective reactors 50.

In an alternative example embodiment, aperture lenses 20 are provided simply by the openings 22 in the plate 110 without the use of any inserted lenses. In such cases, the plate 110 with opening 22 will not from part of the reactor pressure boundary 60. Rather, a ring-style pressure barrier could be included at some other location within the transmission line structure 100, for example a radial pressure barrier structure could be located between second central conductor 130 and the outer cylindrical wall 142 of the coaxial transmission line section 40.

The operating frequency and corresponding components dimensions and dielectric properties indicated above are illustrative only. The system 100, including MMC coupling device 102, can be configured to provide optimized performance at different intended operating frequencies. In various examples, different systems 100 may be configured to operate at operating frequencies within the microwave frequency range of 300 MHz to 30 GHZ. In example embodiments, the frequency of operation is selected from among the Industrial, Scientific & Medical (ISM) frequency bands. In one example embodiment, a system 100 is configured to operate at approximately 915 MHZ, and in a further example embodiment, system 100 is configured to operate at approximately 2450 MHZ. As used herein, “approximately” refers to a range of plus or minus 15% of the stated value.

In an non-limiting illustrate example embodiment, the relative sizes and dimensional properties of the components of the microwave transmission structure 100 are selected with an objective of achieving energy efficient transmission based on the frequency and energy level of the microwaves that are being used for a particular reactor application. By way of non-limiting example in the case of a microwave frequency of 915 MHZ, the dimensions of the microwave transmission structure 100 can be as follows: (1) Rectangular waveguide section 20: 9.75″×4.88″; (2) Coaxial transmission line section outer conductive wall section 142: 3″ diameter; (3) First central conductor 80 length: 5″, diameter: 1.25″ (4) Second central conductor 130 diameter: 0.5″; (5) mode converter cylindrical conductive wall section 115: length: 5″, diameter 5.5″ (6) mode converter tapering conductive wall section 140: length: 3.25″ (7) Aperture lens 120 length: 5″; diameter 3.5″.

Although the microwave transmission structure 100 has been described above in the context of converting TE mode microwaves to TEM mode microwaves, the structure can also be applied in a reverse TEM mode to TE mode microwave conversion application wherein a source of microwave energy is applied to microwave transmission line section 40 for extraction from the rectangular waveguide section 20.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” or “example” means “serving as an example, instance, or illustration,” and should not be construed as preferred or advantageous over other configurations disclosed herein.

As used herein, the terms “about”, “approximately”, and “substantially” are meant to cover variations that may exist in the upper and lower limits of the ranges of values, such as variations in properties, parameters, and dimensions.

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item.

Although the present disclosure describes methods and processes with steps in a certain order, one or more steps of the methods and processes can be omitted or altered as appropriate. One or more steps can take place in an order other than that in which they are described, as appropriate.

The present disclosure can be embodied in other specific forms without departing from the subject matter of the claims. The described example implementations are to be considered in all respects as being only illustrative and not restrictive. Selected features from one or more of the above-described implementations can be combined to create alternative implementations not explicitly described, features suitable for such combinations being understood within the scope of this disclosure.

All values and sub-ranges within disclosed ranges are also disclosed. Also, although the systems, devices and processes disclosed and shown herein can include a specific number of elements/components, the systems, devices and assemblies could be modified to include additional or fewer of such elements/components. For example, although any of the elements/components disclosed can be referenced as being singular, the implementations disclosed herein could be modified to include a plurality of such elements/components. The subject matter described herein intends to cover and embrace all suitable changes in technology.

1. A microwave transmission structure comprising a mode converter coupling a rectangular waveguide section in which microwave energy propagates in a first mode to a transmission line section in which microwave energy propagates in a second mode,
the waveguide section, the mode converter and the transmission line section being cooperatively configured and arranged along a common propagation axis such that microwave energy can propagate in a linear direction through the microwave transmission structure while undergoing a mode conversion at the mode converter.

2. The microwave transmission structure of claim 1 wherein the first mode is a transverse electric (TE) mode and the second mode is a transverse electromagnetic mode (TEM) mode.

3. The microwave structure of claim 2 wherein the mode converter includes an electrically conductive element that forms a terminal wall of the waveguide section, the electrically conductive element including at least one aperture lens extending there through, the aperture lens enabling a TE mode component of the microwave energy to propagate between the waveguide section and an interior of the mode converter.

4. The microwave transmission structure of claim 3 wherein the mode converter provides an internal pressure barrier between the transmission line section and the waveguide transmission section.

5. The microwave transmission structure of claim 4 wherein the aperture lens is formed from a solid dielectric material, the electrically conductive element and the aperture lens forming the internal pressure barrier.

6. The microwave transmission structure of claim 3 wherein the mode converter includes a first central conductor electrically coupled to the electrically conductive element, the first central conductor extending along a central axis of the microwave transmission structure from a first side of the electrically conductive element into the waveguide section.

7. The microwave transmission structure of claim 6 wherein the aperture lens is radially offset relative to the central axis.

8. The microwave transmission structure of claim 7 comprising a plurality of the aperture lenses extending through the electrically conductive element, the aperture lenses being uniformly spaced about the central axis.

9. The microwave transmission structure of claim 6 wherein a second end of the first central conductor is coupled by a conductive structure to a wall of the waveguide section at a location that is spaced apart from the first side of the electrically conductive element.

10. The microwave transmission structure of claim 6, comprising:
a second central conductor electrically coupled to the electrically conductive element, the second central conductor extending in an opposite direction than the first central conductor along the central axis from a second side of the electrically conductive element, the second central conductor including a first portion extending through and forming a central conductor of the mode converter and a second portion forming a central conductor of the transmission line section,
wherein
the transmission line section comprises an electrically conductive outer wall that is radially spaced from the second portion of the second central conductor;
the mode converter comprises an electrically conductive cylindrical wall section extending from the electrically conductive element to a conductive tapering wall section that extends from the conductive cylindrical wall section to the electrically conductive outer wall of the transmission line section, the cylindrical wall section and tapering wall section being radially spaced from the first portion of the second central conductor.

11. The microwave transmission structure of claim 10 where the first central conductor is arranged to provide a TEM mode component within the waveguide structure to enable the aperture lens to propagate the TE mode component between the waveguide section and the interior of the mode converter.

12. The microwave transmission structure of claim 10 wherein the waveguide section, mode converter, and transmission line section are cooperatively configured such that alignment of an electric field component in the lens aperture is coincident with an electric field component of a TEM mode component within the cylindrical wall section, such that the co-aligned electric field components allow the transmission of electromagnetic microwave energy between the waveguide section and the transmission line section.

13. The microwave transmission structure of claim 1 wherein the waveguide section, the mode converter and the transmission line section collectively define a common conductive outer surface of the microwave transmission structure.

14. The microwave transmission structure of claim 1 wherein the waveguide section, the mode converter and the transmission line section collectively define a common conductive outer surface of the microwave transmission structure.

15. The microwave transmission structure of claim 1 wherein the microwave transmission structure is arranged to provide microwave energy to an interior of a reactor operating under positive pressure, the microwave transmission structure comprising a sealing structure on an outer surface thereof at a location of entry of the microwave transmission structure to the reactor, the sealing structure forming part of a pressure boundary of the reactor.

16. A microwave reactor system comprising a plurality of reactors, each of the reactors being coupled to a respective microwave transmission structure according to for receiving microwave energy therefrom, each respective microwave transmission structure comprising:
a mode converter coupling a rectangular waveguide section in which microwave energy propagates in a first mode to a transmission line section in which microwave energy propagates in a second mode,
the waveguide section, the mode converter and the transmission line section being cooperatively configured and arranged along a common propagation axis such that microwave energy can propagate in a linear direction through the microwave transmission structure while undergoing a mode conversion at the mode converter.

17. A method of transmitting microwave energy using a microwave transmission structure according to, that comprises a mode converter coupling a rectangular waveguide section in which microwave energy propagates in a first mode to a transmission line section in which microwave energy propagates in a second mode, the waveguide section, the mode converter and the transmission line section being cooperatively configured and arranged along a common propagation axis such that microwave energy can propagate in a linear direction through the microwave transmission structure while undergoing a mode conversion at the mode converter, the method comprising:
receiving microwave energy at the waveguide section from a microwave generator;
propagating the microwave energy along the waveguide section in the first mode;
converting, at the mode converter, the microwave energy from the first mode to the second mode while propagating the microwave energy through the mode converter to the transmission line section; and
propagating the microwave energy along the transmission line section in the second mode.

18. The method of claim 17, wherein the mode converter includes an electrically conductive element that forms a terminal wall of the waveguide section, the electrically conductive element including at least one aperture lens extending there through, the aperture lens enabling a TE mode component of the microwave energy to propagate between the waveguide section and an interior of the mode converter, and the first mode is a transverse electric (TE) mode and the second mode is a transverse electromagnetic mode (TEM) mode.

19. The microwave reactor system of claim 16, wherein for each respective microwave transmission structure, the first mode is a transverse electric (TE) mode and the second mode is a transverse electromagnetic mode (TEM) mode, and the mode converter includes an electrically conductive element that forms a terminal wall of the waveguide section, the electrically conductive element including at least one aperture lens extending there through, the aperture lens enabling a TE mode component of the microwave energy to propagate between the waveguide section and an interior of the mode converter.
